(19) United States
(12) Patent Application Publication
(10) Pub. No.: US 2026/0116244 A1
(43) Pub. Date: Apr. 30, 2026

(54) MANAGEMENT SYSTEM

(71) Applicant: TOYOTA JIDOSHA KABUSHIKI KAISHA, Toyota-shi (JP)

(72) Inventor: Kosuke MIURA, Nagakute-shi (JP)

(73) Assignee: TOYOTA JIDOSHA KABUSHIKI KAISHA, Toyota-shi (JP)

(21) Appl. No.: 19/317,164

(22) Filed: Sep. 3, 2025

(30) Foreign Application Priority Data
Oct. 29, 2024 (JP) 2024-189505

(51) Int. Cl. B60L 53/66; B60H 1/32; B60L 53/65

(52) U.S. Cl. CPC B60L 53/665; B60H 1/3205; B60L 53/65

(57) ABSTRACT

The management system provides the vehicle with a charging plan to the vehicle having a battery charged from an external power source. The first server transmits a plurality of charging plans to the vehicle to the second server. The second server arbitrates the plurality of charging plans. The second server stores the charging plan of the arbitration result. When the management system retransmits the charging plan of the arbitration result to the vehicle, the first server transmits the retransmission request DR for retransmitting the charging plan of the arbitration result and the vehicle identifier ID indicating the vehicle transmitting the retransmission request to the second server without transmitting the charging plan to the second server. When the second server acquires the retransmission request, the second server transmits a charging plan of the stored arbitration result to the vehicle identified by the vehicle identifier ID.

### CROSS-REFERENCE TO RELATED APPLICATION

This application claims priority to Japanese Patent Application No. 2024-189505 filed on Oct. 29, 2024. The disclosure of the above-identified application, including the specification, drawings, and claims, is incorporated by reference herein in its entirety.

### BACKGROUND

### 1. Technical Field

The present disclosure relates to a management system.

### 2. Description of Related Art

Japanese Unexamined Patent Application Publication No. 2024-043088 (JP 2024-043088 A) describes a vehicle management system that provides a charging plan for a vehicle including a battery charged from an external power source. The vehicle management system includes a first server and a second server.

### SUMMARY

In the vehicle management system as described in JP 2024-043088 A, the first server occasionally transmits a plurality of charging plans for the vehicle to the second server. Further, when the second server arbitrates the charging plans, the second server transmits the charging plan as the arbitration result to the vehicle.

In this case, if the first server transmits the target charging plan to the second server when the vehicle management system retransmits the charging plan as the arbitration result to the vehicle, the load of communication between the first server and the second server may become excessively high.

In order to address the above issue, an aspect provides a management system that provides a charging plan for a vehicle including a battery charged from an external power source to the vehicle, the management system including a first server and a second server, in which:
the first server transmits a plurality of charging plans for the vehicle to the second server;
the second server arbitrates the charging plans, stores the charging plan as an arbitration result, and transmits the charging plan as the arbitration result to the vehicle; and
when the charging plan as the arbitration result is to be retransmitted to the vehicle, the first server transmits a retransmission request for retransmitting the charging plan as the arbitration result and an identifier of the vehicle to which the retransmission request is to be transmitted to the second server, without transmitting the charging plan to the second server, and
when the retransmission request is acquired, the second server transmits the stored charging plan as the arbitration result to the vehicle identified by the identifier of the vehicle.

According to the above configuration, when the vehicle management system retransmits the charging plan as the arbitration result to the vehicle, the first server does not transmit the charging plan to the second server. Therefore, the vehicle management system can suppress the load of communication between the first server and the second server becoming excessively high due to the first server transmitting the charging plan.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle management system;

FIG. 2 is an explanatory diagram illustrating a charging plan;

FIG. 3 is a sequence chart showing the flow of information in the vehicle management system;

FIG. 4 is a flowchart showing a series of processes performed by the first server; and

FIG. 5 is a flowchart illustrating a series of processes performed by the second server.

### DETAILED DESCRIPTION OF EMBODIMENTS

### Overview of the Management System

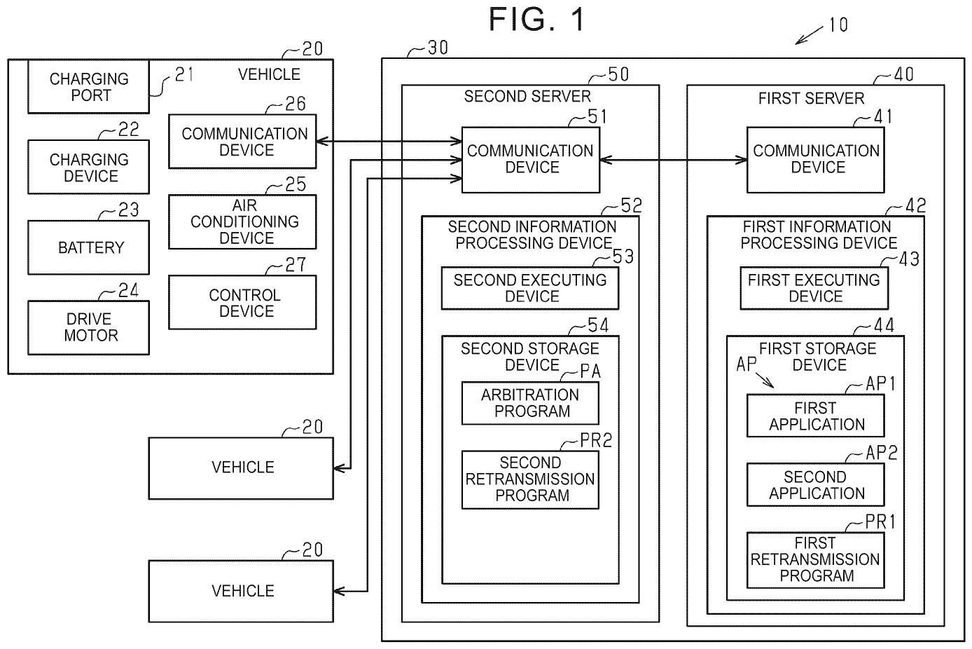

As illustrated in FIG. 1, the vehicle management system 10 includes a plurality of vehicles 20 and a management system 30.

### Overview of the Vehicle

The vehicle 20 includes a charging port 21, a charging device 22, a battery 23, and a drive motor 24. The vehicles 20 are battery electric vehicle.

The charging port 21 is connected to a charging connector outside the vehicle 20. When the charging connector is connected to the charging port 21, the battery 23 can be charged from the external power source of the vehicle 20.

The drive motor 24 is a drive source of the vehicle 20. The drive motor 24 drives the vehicle 20 using the electric power stored in the battery 23. The battery 23 stores electric power for operating the drive motor 24.

The charging device 22 includes a relay for switching connection and disconnection of a power path from the charging port 21 to the battery 23, and a power conversion circuit. The battery 23 is charged by controlling the charging device 22.

The vehicle 20 includes an air conditioning device 25, a communication device 26, and a control device 27. The air conditioning device 25 exchanges heat with the coolant and blows the air whose temperature is adjusted by the heat exchange to the internal space of the vehicle 20. The air conditioning device 25 adjusts heat exchange and air blowing in accordance with a set temperature T, which is a target value of the temperature of the indoor space of the vehicle 20.

The communication device 26 is capable of communicating with the management system 30 via a wireless communication network. The control device 27 controls the charging of the battery 23 and the operation of the air conditioning device 25 in accordance with the charging plan PL received from the management system 30. In FIG. 1, only one vehicle 20 among the plurality of vehicles 20 is shown in detail, and detailed description of the other vehicles 20 is omitted.

### Management System Overview

The management system 30 manages the charging plan PL of the vehicles 20. The management system 30 provides charging plan PL to the vehicle 20 to the vehicle 20.

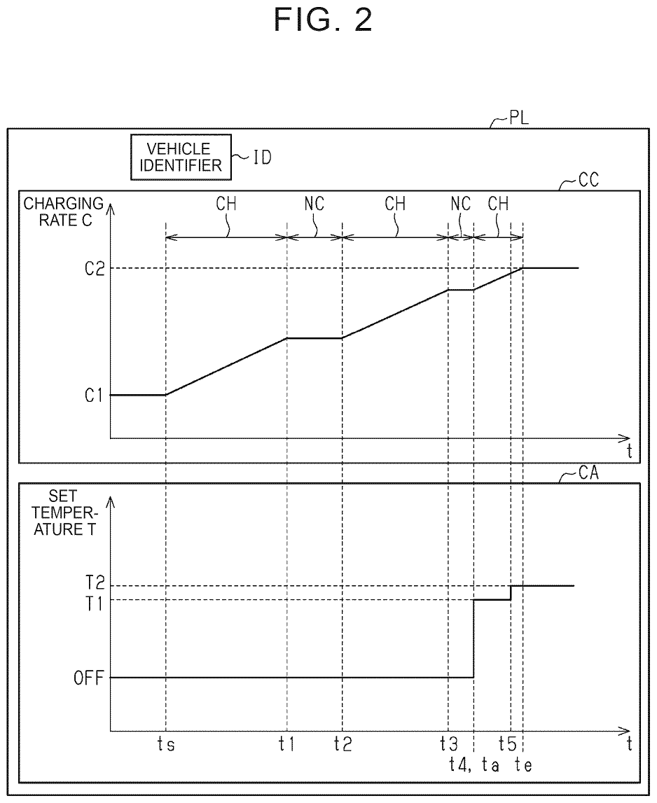

As illustrated in FIG. 2, the charging plan PL includes a vehicle identifier ID, a charge control information CC, and an air-conditioning control information CA. The vehicle identifier ID is information for identifying the target vehicle 20.

The charge control information CC includes data indicating a charge starting time ts at which charge of the battery 23 is started and a charge ending time the at which charge of the battery 23 is ended. The charge control information CC includes data indicating a charge period CH and a non-charge period NC for charging from the charge starting time ts to the charge ending time te.

In the embodiment illustrated in FIG. 2, from the charging start time ts to the charging end time the, a period from the charging start time ts to the time t1 after the charging start time ts is the charge period CH. The period from the time t1 to the time t2 after the time t1 is the non-charge period NC. The charge period CH is from the time t2 to the time t3 after the time t2. The period from the time t3 to the time t4 after the time t3 is the non-charge period NC. The charge period CH is from the time t4 to the charging end time the after the time t4. Thus, the charge control information CC is planned such that the charge rate C at the charge starting time ts is the first charge rate C1, while the charge rate C at the charge ending time the is the second charge rate C2.

The charge control information CC is control information of the air conditioning device 25 from the charge start time ts to the charge end time te. The charge control information CC includes a set temperature T, which is setting information of the air conditioning device 25, and an air-conditioning start time ta at which the operation of the air conditioning device 25 is started.

In the embodiment illustrated in FIG. 2, the air-conditioning starting time ta is a time t4. Until the air-conditioning starting time ta, the air conditioning device 25 is not operated. The set temperature T becomes the first temperature T1 from the air-conditioning start time ta to the time t5 after the air-conditioning start time ta. From the time t5 to the charging-end time the after the time t5, the set temperature T is in the second temperature T2 higher than the first temperature T1. In the example illustrated in FIG. 2, the air conditioning device 25 performs a cooling operation.

As illustrated in FIG. 1, the management system 30 includes a first server 40 and a second server 50.

The first server 40 transmits a plurality of charging plan PL to the vehicles 20 to the second server 50. The first server 40 includes a communication device 41 and a first information processing device 42. The communication device 41 is capable of communicating with the second server 50 via a wireless communication network.

The first information processing device 42 includes a first executing device 43 and a first storage device 44. The first executing device 43 is a CPU. The first storage device 44 is a memory.

The first storage device 44 stores a plurality of application AP. The application AP is a program for creating charging plan PL by causing the first executing device 43 to execute the program. The plurality of application AP create differing charging plan PL. The plurality of application AP includes a first application AP1 and a second application AP2.

The first application AP1 is, for example, an application AP that creates a charging plan PL in accordance with an electric charge due to charging. The second application AP2 is, for example, an application AP that creates a charging plan PL in accordance with a load of an external power source for charging.

When the first executing device 43 executes the respective application AP, the first executing device 43 creates a plurality of charging plan PL. Then, the first executing device 43 transmits the created charging plan PL to the second servers 50 via the communication device 41.

The first storage device 44 stores various programs. The first executing device 43 executes various programs stored in the first storage device 44. Accordingly, the first information processing device 42 performs a series of processes related to the charging plan PL. Specifically, the first storage device 44 stores the first retransmission program PR1. The first retransmission program PR1 is a program for causing the first executing device 43 to execute a process for retransmitting the charging plan PL. The process when the first retransmission program PR1 is executed will be described later.

The second server 50 arbitrates the plurality of charging plan PL received from the first server 40. The second servers 50 store the charging plan PL of the arbitration outcome. The second server 50 includes a communication device 51 and a second information processing device 52. The communication device 51 is capable of communicating with the first server 40 via a wireless communication network. The communication device 51 can communicate with the vehicle 20 via a wireless communication network.

The second information processing device 52 includes a second executing device 53 and a second storage device 54. The second executing device 53 is a CPU. The second storage device 54 is a memory. The second storage device 54 stores various programs. The second executing device 53 executes various programs stored in the second storage device 54. Accordingly, the second information processing device 52 performs a series of processes related to the charging plan PL.

Specifically, the second storage device 54 stores the arbitration program PA and the second retransmission program PR2. The arbitration program PA is a program for causing the second executing device 53 to execute, thereby arbitrating a plurality of charging plan PL. The second executing device 53 executes the arbitration program PA to arbitrate a plurality of charging plan PL. The second executing device 53 arbitrates by selecting a charging plan PL at the earliest charge starting time ts t from among the plurality of acquired charging plan PL.

The second retransmission program PR2 is a program for causing the second executing device 53 to execute a process for retransmitting the charging plan PL. The process when the second retransmission program PR2 is executed will be described later.

Further, the second storage device 54 stores charging plan PL of arbitrated arbitration among the plurality of charging plan PL received from the first servers 40. When storing the charging plan PL, the second storage device 54 compresses and stores the charging plan PL of the arbitration result.

### Flow of Charging Plan in Vehicle Management System

Next, a flow of charging plan PL in the vehicle management system 10 will be described.

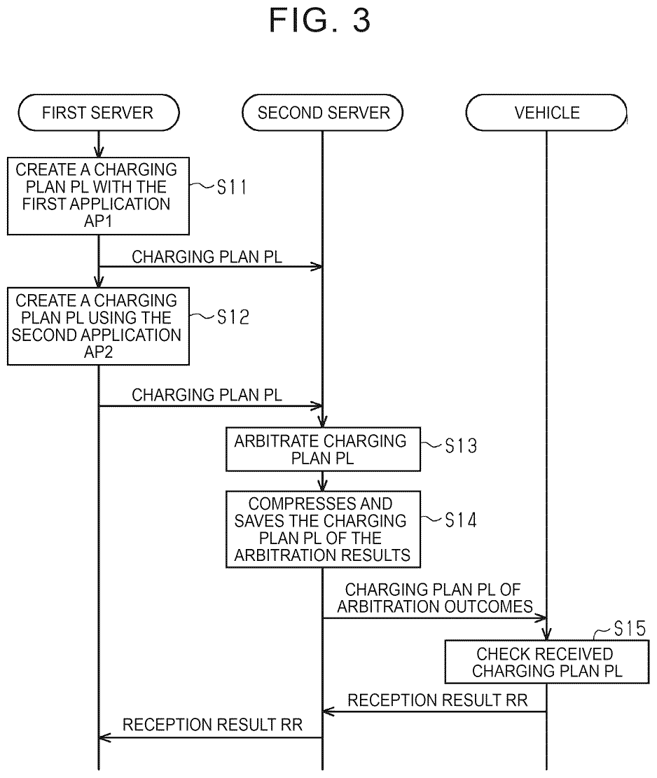

As illustrated in FIG. 3, first, in the first server 40, the first executing device 43 performs a S11 process. In S11, the first executing device 43 executes the first application AP1 to create the charging plan PL. Thereafter, the first executing device 43 transmits the created charging plan PL from the communication device 41 to the second servers 50.

Thereafter, the first executing device 43 performs S12 process. In S12, the first executing device 43 executes the second application AP2 to create the charging plan PL. Thereafter, the first executing device 43 transmits the created charging plan PL from the communication device 41 to the second servers 50.

After that, when the second server 50 acquires the plurality of charging plan PL from the first server 40, the second executing device 53 performs S13 process. In S13, the second executing device 53 arbitrates the plurality of charging plan PL. Specifically, the second executing device 53 arbitrates by selecting the charging plan PL having the earliest charging starting time ts among the plurality of charging plan PL acquired from the first servers 40. Thereafter, the second executing device 53 advances the process to S14.

In S14, the second executing device 53 stores the second executing device 53 by compressing the charging plan PL, which is the mediation outcome mediated by S13, into the second storage device 54. On the other hand, the second executing device 53 does not store the charging plan PL, which is not the charging plan PL of the arbitration result, in the second storage device 54.

Thereafter, the second executing device 53 transmits the charging plan PL of the arbitration result to the target vehicle 20. After that, when the vehicle 20 acquires the charging plan PL of the arbitration outcome from the second server 50, the control device 27 performs S15 process.

In S15, the control device 27 checks the charging plan PL of the arbitration. Specifically, the control device 27 confirms whether or not there is no missing information included in the acquired charging plan PL.

For example, the control device 27 determines that there is a missing period in which neither the charge period CH nor the non-charge period NC exists from the charging starting time ts to the charging ending time te. When there is no missing, the control device 27 determines that the reception result RR is successful.

On the other hand, the control device 27 determines that there is no missing when all the periods from the charging starting time ts to the charging ending time the are in the charge period CH or the non-charge period NC. The control device 27 determines that the reception result RR fails when there is a missing.

Then, the control device 27 transmits the reception result RR to the second servers 50 via the communication device 26. The reception result RR indicates that the reception result RR of the result of confirming the charging plan PL is successful or unsuccessful.

Thereafter, the second servers 50 receive the reception result RR. The second server 50 transmits the received reception result RR to the first server 40. After that, the first server 40 and the second server 50 perform processing when the reception result RR is acquired, and the vehicle management system 10 ends the series of processing.

### Processing of the First Server in Retransmitting the Charging Plan

When the reception result RR is acquired from the second servers 50, the first executing device 43 starts the execution of the first retransmission program PR1.

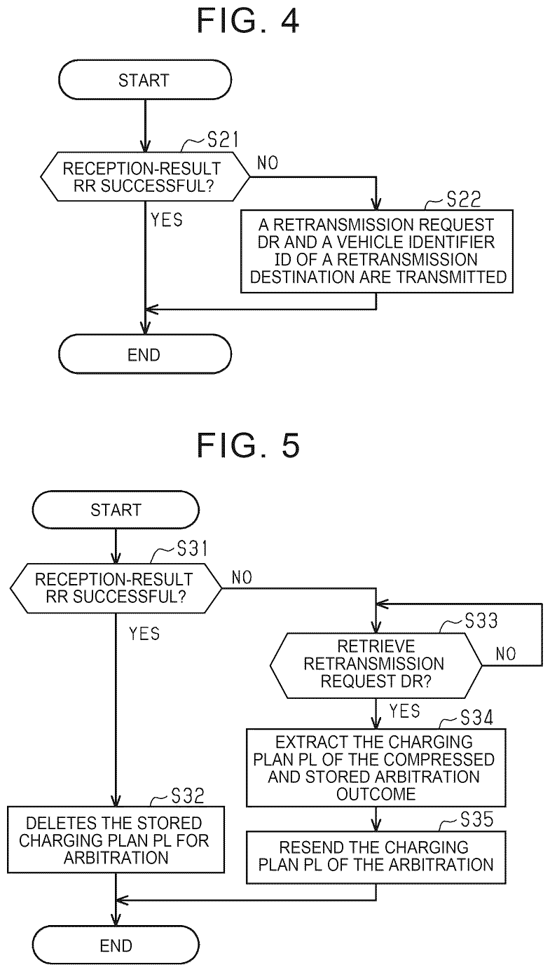

As illustrated in FIG. 4, when the first executing device 43 starts executing the first retransmission program PR1, the first executing device 43 first performs a S21 process. In S21, the first executing device 43 determines whether or not the acquired reception result RR is successful.

When the acquired reception result RR is successful (S21: YES), the first executing device 43 ends the series of processes of this time. On the other hand, when the obtained reception result RR fails (S21: NO), the first executing device 43 advances the process to S22.

In S22, the first executing device 43 transmits the retransmission request DR and the vehicle identifier ID indicating the retransmission destination vehicle 20 to the second servers 50. The retransmission request DR indicates requesting a charging plan PL of the arbitration outcome to be transmitted again. Thereafter, the first executing device 43 ends the series of processes of this time.

### Processing of the Second Server in Retransmitting the Charging Plan

When the reception result RR is acquired from the vehicles 20, the second executing device 53 starts the execution of the second retransmission program PR2.

As illustrated in FIG. 5, when the second executing device 53 starts executing the second retransmission program PR2, the second executing device 53 first performs S31 process. In S31, the second executing device 53 determines whether or not the acquired reception result RR is successful.

When the acquired reception result RR is successful (S31: YES), the second executing device 53 advances the process to S32. In S32, the second executing device 53 deletes the stored charging plan PL. Thereafter, the second executing device 53 ends the series of processes.

On the other hand, when the acquired reception result RR fails (S32: NO), the second executing device 53 advances the process to S33. In S33, the second executing device 53 determines whether or not the retransmission request DR has been acquired from the first servers 40.

When the second executing device 53 has not acquired the retransmission request DR (S33: NO), the second executing device 53 repeats S33 process. On the other hand, when the second executing device 53 acquires the retransmission request DR (S33: YES), the second executing device 53 advances the process to S34.

In S34, the second executing device 53 decompresses the charging plan PL of the compressed and stored arbitration result. Thereafter, the second executing device 53 advances the process to S35.

In S35, the second executing device 53 retransmits the charging plan PL of the decompressed arbitration. Specifically, the second executing device 53 transmits the charging plan PL of the decompressed arbitration result to the vehicle 20 indicated by the vehicle identifier ID acquired when the retransmission request DR is acquired. Thereafter, the second executing device 53 ends the series of processes.

### Operation of this Embodiment

### Effect of this Embodiment

(1) The management system 30 provides charging plan PL to the vehicle 20 to the vehicle 20. The management system 30 includes a first server 40 and a second server 50. The first server 40 transmits a plurality of charging plan PL to the vehicles 20 to the second server 50. The second servers 50 arbitrate the plurality of charging plan PL. The second servers 50 store the charging plan PL of the arbitration outcome. When the management system 30 retransmits the charging plan PL of the arbitration result to the vehicle 20, the first server 40 does not transmit the charging plan PL to the second server 50. On the other hand, the first server 40 transmits only the retransmission request DR and the vehicle identifier ID indicating the vehicle 20 that transmits the retransmission request DR to the second server 50. When the retransmission request DR is acquired, the second server 50 transmits the stored charging plan PL of the arbitration result to the vehicle 20 identified by the vehicle identifier ID.

According to the above configuration, when the management system 30 retransmits the charging plan PL of the arbitration result to the vehicle 20, the first server 40 does not transmit the charging plan PL to the second server 50. Therefore, the management system 30 can suppress the communication load between the first server 40 and the second server 50 becoming excessively high due to the first server 40 transmitting the charging plan PL.
(2) When storing the charging plan PL of the arbitration result, the second servers 50 compress and store the charging plan PL of the arbitration result. When transmitting the charging plan PL to the vehicles 20, the second servers 50 decompress and then transmit the charging plan PL of the stored arbitration outcome. According to the above configuration, when the second server 50 stores the charging plan PL, it is possible to suppress the storage capacity to be used becoming excessively large.
(3) When the reception result RR received from the vehicle 20 indicates successful, the second server 50 deletes the charging plan PL of the stored arbitration result. According to the above configuration, by storing the charging plan PL in which the second server 50 does not need to store the charging plan PL resulting from the arbitration, it is possible to suppress using wasteful storage space.
(4) The charging plan PL includes a charge control information CC. The charge control information CC includes a charge starting time ts for starting the charge of the battery 23 and a charge ending time the for ending the charge of the battery 23. The charge control information CC includes data indicating a charge period CH and a non-charge period NC for charging from the charging starting time ts to the charging ending time te. According to the above configuration, since the data capacity of the charging plan PL is correspondingly increased, the management system 30 can obtain a large advantage that the first server 40 does not retransmit the charging plan PL to the second server 50.
(5) The charging plan PL includes an air-conditioning control information CA. The air-conditioning control information CA includes time-series data of the set temperature T, which is setting information of the air conditioning device 25, and an air-conditioning start time ta at which the operation of the air conditioning device 25 is started. According to the above configuration, since the data capacity of the charging plan PL is correspondingly increased, the management system 30 can obtain a large advantage that the first server 40 does not retransmit the charging plan PL to the second server 50.

### Example of Change

The present embodiment can be modified and implemented as follows. The present embodiment and the following modifications can be combined unless technical inconsistency arises.
The control device 27 may be configured as a circuitry including one or more processors that execute various processes in accordance with a computer program (software). Note that the control device 27 may be configured as a circuit including one or more dedicated hardware circuits such as an application-specific integrated circuit (ASIC) that executes at least some of the various processes, or a combination thereof. The processor includes memories such as CPU and RAM and ROM. The memory stores a program code or a command configured to cause the CPU to execute the process. Memory or computer readable media includes any available media that can be accessed by a general purpose or special purpose computer. The same applies to the first information processing device 42 and the second information processing device 52.
The plurality of charging plan PL created by the first information processing device 42 may be created by executing the same application AP. For example, even if the same application AP is executed, the first information processing device 42 may create different charging plan PL as a result of different conditions of the battery 23 of the vehicles 20 due to different times of execution.
The content of the charging plan PL is not limited to the exemplary embodiment. The charge-start time ts may not be a reserved time. For example, the charge initiation time ts may be immediate. In addition, for example, the charge period CH may be data indicating power that changes with respect to the time.
The charging plan PL may not include the charge start time ts, the charge end time te, and data indicating the charge period CH and the non-charge period NC to be charged from the charge start time ts to the charge end time te. Further, for example, the charging plan PL may not include the air-conditioning control information CA. That is, the charging plan PL may not include the setting data of the air conditioning device 25 and the air-conditioning starting time ta.
The timing at which the second servers 50 arbitrate may be, for example, when a second charging plan PL is received after one charging plan PL is received. After that, the timing at which the second servers 50 arbitrate again may be the time when a new charging plan PL is received while the charging plan PL of the arbitration result is stored. Further, for example, the second servers 50 may determine whether or not a plurality of charging plan PL have been received in a predetermined time interval. Here, when a plurality of charging plan PL are received during a predetermined time interval, the second servers 50 may arbitrate the plurality of charging plan PL.
The arbitration method of the second server 50 is not limited to the example of the above-described embodiment. For example, the second executing device 53 may arbitrate by selecting the charging plan PL having the earliest charge ending time te. Further, for example, the second executing device 53 may arbitrate by selecting the charging plan PL having the highest second charge rate C2 at the charge ending time te. Further, for example, the second executing device 53 may arbitrate by creating a charging plan PL that combines the content of the plurality of charging plan PL. Specifically, when adjusting the two charging plan PL, the second executing device 53 may use the charging plan PL obtained by combining the charge control information CC of one charging plan PL and the air-conditioning control information CA of the other charging plan PL as the charging plan PL.
When storing the charging plan PL of the arbitration result, the second servers 50 may not compress and store the charging plan PL of the arbitration result. When the charging plan PL is transmitted to the vehicles 20, the second servers 50 may decompress the stored charging plan PL of the arbitration outcome before transmitting it.
When the vehicle 20 successfully receives the charging plan PL of the arbitration result, the second server 50 may not delete the charging plan PL of the stored arbitration result.
The method of determining the reception result is not limited to the example of the above-described embodiment. For example, when the second server 50 acquires the reception result RR indicating that the charging plan PL has been received from the vehicle 20, the second server 50 may execute the second retransmission program PR2 to perform S32 process. On the other hand, when the second server 50 does not receive the reception result RR indicating that the charging plan PL has been received from the vehicle 20 for a predetermined time, the second server 50 may execute the second retransmission program PR2 to perform S33 process. When the first server 40 does not receive the reception result RR from the second server 50 for a predetermined time, the first server 40 may execute the first retransmission program PR1 to perform S22 process.

What is claimed is:

1. A management system that provides a charging plan for a vehicle including a battery charged from an external power source to the vehicle, the management system comprising
a first server and a second server, wherein:
the first server transmits a plurality of charging plans for the vehicle to the second server;
the second server arbitrates the charging plans, stores the charging plan as an arbitration result, and transmits the charging plan as the arbitration result to the vehicle; and
when the charging plan as the arbitration result is to be retransmitted to the vehicle,
the first server transmits a retransmission request for retransmitting the charging plan as the arbitration result and an identifier of the vehicle to which the retransmission request is to be transmitted to the second server, without transmitting the charging plan to the second server, and
when the retransmission request is acquired, the second server transmits the stored charging plan as the arbitration result to the vehicle identified by the identifier of the vehicle.

2. The management system according to claim 1, wherein the second server is configured to
compress and store the charging plan as the arbitration result when storing the charging plan as the arbitration result, and
decompress and transmit the stored charging plan as the arbitration result when transmitting the charging plan to the vehicle.

3. The management system according to claim 1, wherein when the vehicle has successfully received the charging plan as the arbitration result, the second server deletes the stored charging plan as the arbitration result.

4. The management system according to claim 1, wherein the charging plan includes a charging start time to start charging of the battery, a charging end time to end the charging of the battery, and data indicating a charging period for which the charging is performed from the charging start time to the charging end time and a non-charging period for which the charging is not performed.

5. The management system according to claim 4, wherein the charging plan further includes setting information of an air conditioning device of the vehicle and an air-conditioning start time to start operation of the air conditioning device.
